(19) United States
(12) Patent Application Publication
(10) Pub. No.: US 2002/0046904 A1
(43) Pub. Date: Apr. 25, 2002

(54) Ladder pad device

(76) Inventor: David J. Richard, Hyde Park, NY (US)

Correspondence Address: Karl F. Milde, Jr., Esq., MILDE, HOFFBERG & MACKLIN, L.L.P., Suite 460, 10 Bank Street, White Plains, NY, 10606, US

(21) Appl. No.: 09/784,270

(22) Filed: Feb. 15, 2001

Related U.S. Application Data
(63) Continuation-in-part of application No. 09/693,774, filed on Oct. 20, 2000, now abandoned.

(51) Int. Cl. E06C 5/32

(52) U.S. Cl. 182/129

(57) ABSTRACT

A ladder pad device is used to add comfort in carrying a ladder. The ladder pad device has a plurality of side faces, a top face connected to the plurality of side faces, a bottom face connected to a plurality of side faces and attachment means covering a majority of one of the side faces to attach the ladder pad device to the ladder.

### CROSS REFERENCE TO RELATED APPLICATION

This application is a continuation-in-part application of U.S. patent application Ser. No. 09/693,774, filed Oct. 20, 2000, now pending.

### FIELD OF THE INVENTION

The present invention relates to a ladder pad device, and more particularly to a device for reducing stress and potential injury to the shoulder area when carrying a ladder.

### BACKGROUND OF THE INVENTION

Workers, such as electricians, painters and handymen often carry ladders of various lengths and various weights for long distances. Carrying ladders, at times, causes undue stress and pain to the shoulder area and other body parts. In addition, the ladders may slip from the shoulder while carrying resulting in potentially harmful injury.

Several protective devices exist in the prior art relating to ladders. One such device is ladder socks disclosed in U.S. Pat. No. 3,993,163 to Barrett. These protective socks are used with ladders having side rails or legs. The socks consist of a pad of resilient polyurethane foam, or other material, selected for its resilient properties and for its ability to fold about a ladder side rail. A securing strap is permanently fastened to the pad by rivets, stitched seams, or any other convenient fastening means. When fastened in place, the socks prevent the ladder rails from marring any work surface upon which the ladder may be leaning.

Another device disclosed in U.S. Pat. No. 1,308,147 to W. A. Cooper relates to sleeping-car ladders. The device is a stepladder of rigid straight form adapted to provide a way for reaching upper berths in sleeping cars and for folding the stepladder in half to facilitate packing away. The ladder consists of two sections pivoted together, and provided with locking means for maintaining the sections in alignment. The upper section may be swung down and used as a prop member, or it may be swung into contact with the lower section to economize space when necessary. The upper section of the ladder provides a rigid connection between the two sections which relieves the hinges and the locking means of practically all strain.

Another device disclosed in U.S. Pat. No. 3,011,585 to E. F. Hamilton is step stool which is collapsible for storage convenience, contains simplified construction, and is fabricated from sheet-metal and metal-tubing. A stool seat in the form of a sheet-metal stamping having a downwardly extending peripheral flange is pivotally connected to the front legs. A seat-supporting rod extends transversely from the seat through openings formed in the lateral stretches of the seat flange adjacent to the rear edge of the seat and having its ends received in aligned openings formed in the inner faces of the legs. In order to prevent the seat from sliding axially on the rod, a bushing is mounted on the rod between each lateral stretch of the flange and its adjacent front leg.

There are problems regarding these devices since they do not enable a ladder to be carried in a manner that eases stress to the shoulder and other body parts. These devices do not contain an auxiliary device that works in conjunction with the ladder to provide a worker with a means to easily carry a ladder in a way that minimizes the possibility of injury. Instead, these devices relate to a protective way to eliminate marring any work surface the ladder is leaning upon, and ways to conveniently storing the ladder by impacting the construction of the ladder device itself.

### SUMMARY AND OBJECTS OF THE INVENTION

Accordingly, the present invention provides for a device for aiding the carrying of a ladder. To attain this, the ladder pad device has a plurality of side faces, a top face connected to the plurality of side faces, a bottom face connected to a plurality of side faces and attachment means covering a majority of one of the side faces to attach the ladder pad device to the ladder.

Accordingly, it is an object of the present invention to provide a ladder pad device for use safely with ladders which protects and supports the person's shoulder area and other body parts when carrying a ladder.

Another object of the present invention is to provide a ladder pad device universally mountable on a ladder of any type.

Still another object of the present invention is to make a ladder pad device that are easily removable for transfer from one ladder to another or removable for cleaning purposes.

Yet another object of the present invention is to furnish a device from materials that are easily cleaned and fabricated from machine-washable materials.

A further object of the present invention is to provide a device having anti-slip surfaces to give the ladder a safer and more secure contact with the shoulder of the person carrying the ladder.

Still a further object of the present invention is to provide a simple to use, convenient method to eliminate strain, minimize injury, and reduce trip hazard.

Another object of the present invention is to make manual ladder transfer from place to place easier and provide a device that adds no significant weight to the ladder and will not interfere with the folding mechanisms of the ladder.

These and still further objects will become apparent hereinafter.

These and other features of the present invention are described in more detail in the following detailed description when taken with the drawings. The scope of the invention, however, is limited only by the claims appended hereto.

### BRIEF DESCRIPTION OF THE DRAWINGS

Various embodiments of the present invention are described and illustrated herein with reference to the drawings in which like items are indicated by the same reference, in which:

FIG. 1 is a perspective view of one preferred embodiment of the ladder pad device according to the present invention.

FIG. 2 is a perspective view of a stepladder showing that position of attachment of the ladder pad device according to the present invention.

FIG. 3 is an enlarged perspective view of a stepladder with the ladder pad device attached to a leg thereof.

FIG. 4 is an enlarged view of the ladder pad device attached to a leg of the ladder of FIG. 3, with the ladder in the closed position.

FIG. 5 is a perspective view of the ladder pad device attached to a leg of the ladder during use by a person.

FIG. 6 is a perspective view of a second preferred embodiment of the ladder pad device according to the present invention.

FIG. 7 is a perspective view of a ladder, similar to FIG. 2 but in the reverse position, showing a ladder brace and mean of attachment of the ladder pad device of FIG. 6 over the ladder brace.

### DETAILED DESCRIPTION OF THE PREFERRED EMBODIMENTS

The preferred embodiments of the present invention will now be described with reference to FIGS. 1-7 of the drawings. Identical elements in the various figures are designated with the same reference numerals.

FIG. 1 is a perspective view of one embodiment of a ladder pad device according to the present invention. The ladder pad device 102 is a rectangular parallelepiped in shape and has four side faces (back face 2, front face 4, left face 6, right face 8) as well as a top face 10 and a bottom face 12. The back face 2 has an attachment means 14, such as Velcro, covering a majority portion of the back face 2. In the preferred embodiment the attachment means 14 is a longitudinal strip having the same shape as the back face 2, as illustrated in FIG. 1.

In the preferred embodiment shown in FIG. 1, the shape of the ladder pad device 102 is rectangular, and the length of the ladder pad device 102 is approximately the length of one of the legs (rails or stiles) of a ladder between the rungs. Alternatively, those skilled in the art will recognize that the ladder pad device 102 can be spherical, round, square, rhomboid, or another shape and can be varying width and length.

In one preferred embodiment, the width of the front and back faces 4 and 2, respectively, is about two and five-eighths inches to allow a secure fit between the inside edges of a rail of a ladder. The width of side faces 6 and 8, top face 10 and bottom face 12 is about one and three-eighths inches to eliminate a bulky appearance while simultaneously protecting the shoulder area during manual ladder transfer. The length of each side face 2, 4, 6, and 8 is about eleven inches to eliminate any trip hazard and cover the entire inside rail between the balance point rungs of the ladder. The length of top face 10 and bottom face 12 is about two and five-eighths inches, which coincides with the width of side faces 2 and 4. The width of the attachment strip 14 is about two inches and the length is about ten and one quarter inches.

The side faces 2, 4, 6, and 8, top face 10 and bottom face 12 are fabricated from material such as canvas, fabric, foam, nonelastic material such as polypropylene, or a flexible material such as rubber, nylon or spandex. The material can be easily cleaned and fabricated since it is machine-washable and it also provides an anti-slip surface. The material covers the interior of the ladder pad device 102 which comprises foam, styrofoam or ethafoam fill. In the preferred embodiment, the ladder pad device 102 is constructed from a durable sewn outside cover over a piece of weather resistant styrofoam fill. The attachment means 14 for attaching the ladder pad device to a ladder may be any known means such as Velcro, rivets, a plethora of snaps or sticky back adhesive.

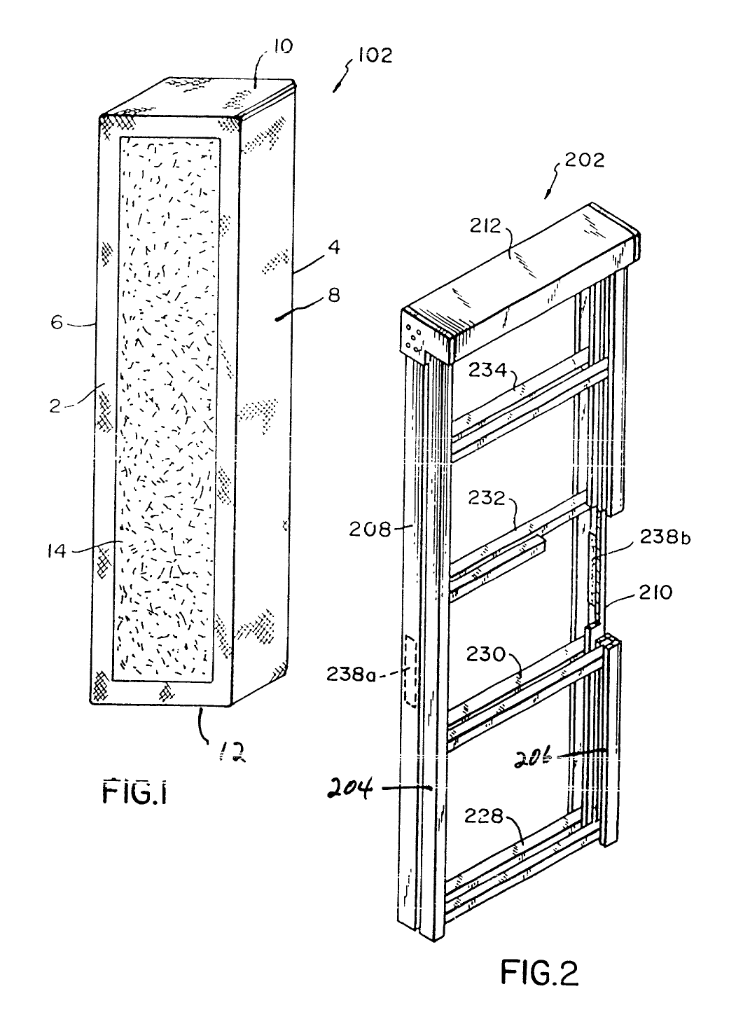

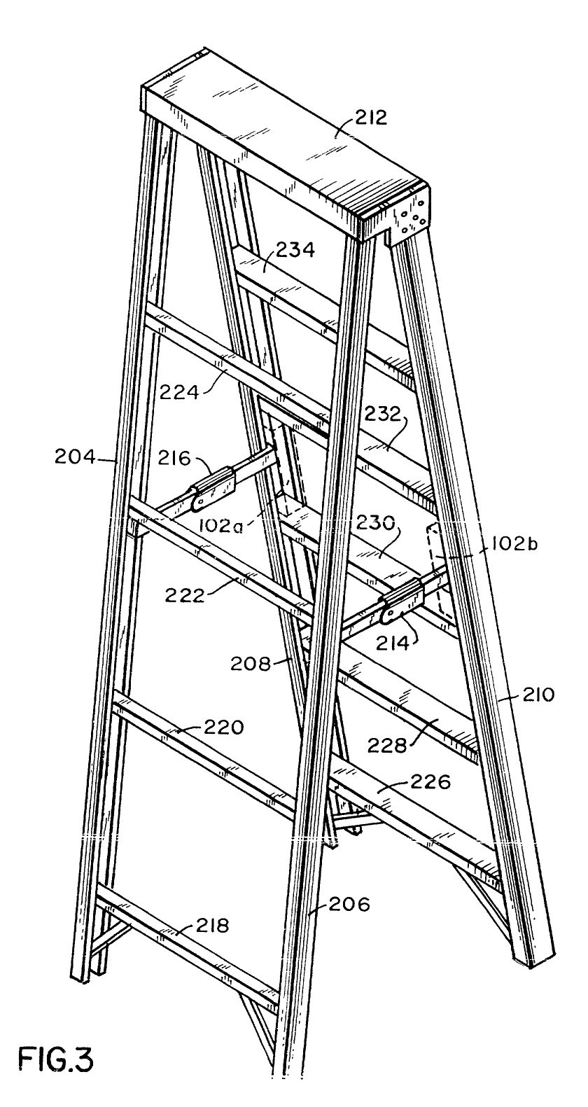

The method of using the ladder pad device 102 is shown in FIGS. 2-5. In FIGS. 2 and 3, a standard 6 foot fiberglass stepladder 202 is depicted. Other stepladders, straight ladders or extension ladders may also be used. The stepladder 202 has two front legs 204, 206 on the stabilizing side, two rear legs 208, 210 on the climbing side, a top step 212, bracing means 214, 216, and a plurality of rungs 218-234 (FIGS. 2 and 3). Some of the rungs 218-224 are situated between the front leg (rail or stile) 204 and front leg 206 and the other rungs 226-234 are situated between the rear leg 208 and rear leg 210. One bracing means 216 attaches between the front leg 204 and rear leg 208 and another bracing means 214 attaches between the front leg 206 and the rear leg 210.

In one preferred method, as shown in FIG. 2, fastening means 238 attached to the ladder is used to mate with the attachment means 14 located on the ladder pad device 102. The fastening means 238a or 238b is placed on the inside of one of the legs 208 or 210, respectively, of the ladder at the ladder's balancing point. If the attachment means 14 is Velcro, then the Velcro fastening means 238 that mates with the Velcro attachment means 14 may be affixed to the ladder so that the ladder pad device 102 adheres to the ladder. Alternatively, the attachment means 14 can be a plurality of snaps and the fastening means 238 will be mate with the plurality of snaps.

As shown in FIG. 3, the ladder pad device 102 is affixed on one or both of the legs 208 and 210 between two of the rungs 230, 232. The device 102a is shown affixed to the leg 208; the device 102b is shown affixed to the leg 210.

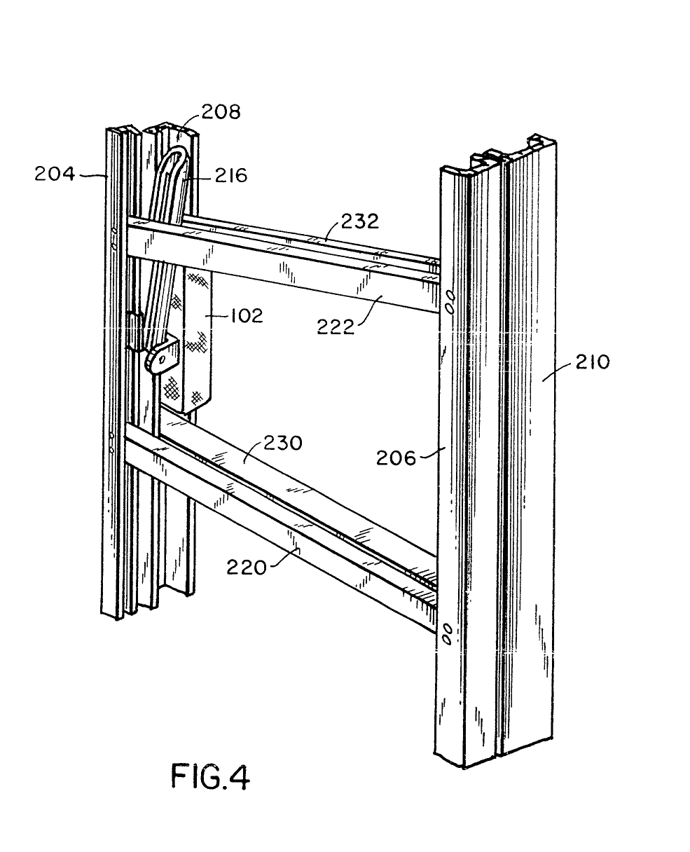

FIG. 4 shows an enlarged view of the ladder pad device 102a according to FIG. 3 when the ladder 202 is in the closed position. The ladder pad device 102 is affixed via the attachment means 14 to the ladder 202 and abuts the bracing means 216 and is situated between the two rungs 230 and 232.

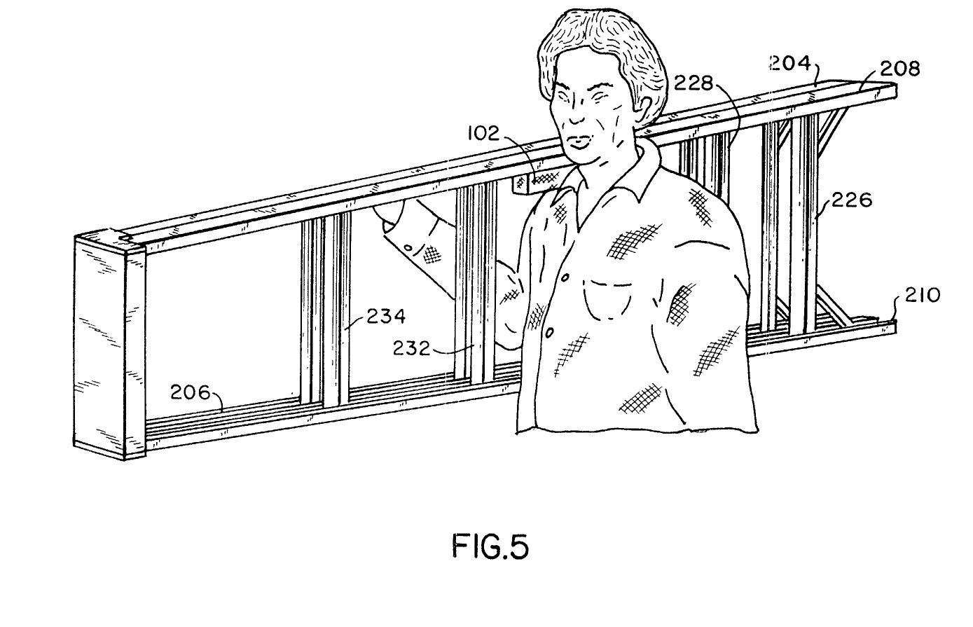

FIG. 5 is a view of the ladder pad device 102 attached to a leg of the ladder during use by a person. The ladder pad device 102 can be used safely with ladders and protects and supports the person's shoulder area and other body parts when carrying a ladder. As shown, the ladder pad device 102 has been affixed to the ladder 202 via the strip 14. The bracing means 214, 216 of the ladder 202 are then folded so that the ladder 202 is in the closed position. The ladder 202 is then turned sideways and lifted so that the ladder pad device 102 is facing downward. The ladder pad device 102 rests on the person's shoulder while the ladder 202 is being carried. The person clasps the ladder 202 with one hand in order to secure the ladder 202 in position. The ladder 202 has been turned sideways and the ladder pad device 102 is facing downward so that it can rest upon a person's shoulder. The ladder pad device 102 allows the user to maintain balance, stability, strength, and self-confidence. Placed on the rail 208, the ladder pad device is most convenient for a right-handed carrier. Placed on the rail 210, the device is convenient for a left-handed carrier.

As will be understood by a person skilled in the art, the surface area on the inside rail 208, 210 of the ladder 202 is minimal. The ladder pad device 102 increases the surface area that comes in contact with the carrying person's shoulder, making manual ladder 202 transfer from place to place easier. In addition, the ladder pad device 102 adds no significant weight to the ladder 202 and will not interfere with the folding mechanisms of the ladder 202. The ladder pad device 102 can be mounted on any standard-size or custom size ladder 202 and can easily be transferred to another ladder or removed for cleaning purposes. The ladder pad device 102 may have an anti-slip surface to provide a safer and more secure contact with the shoulder of the person carrying the ladder.

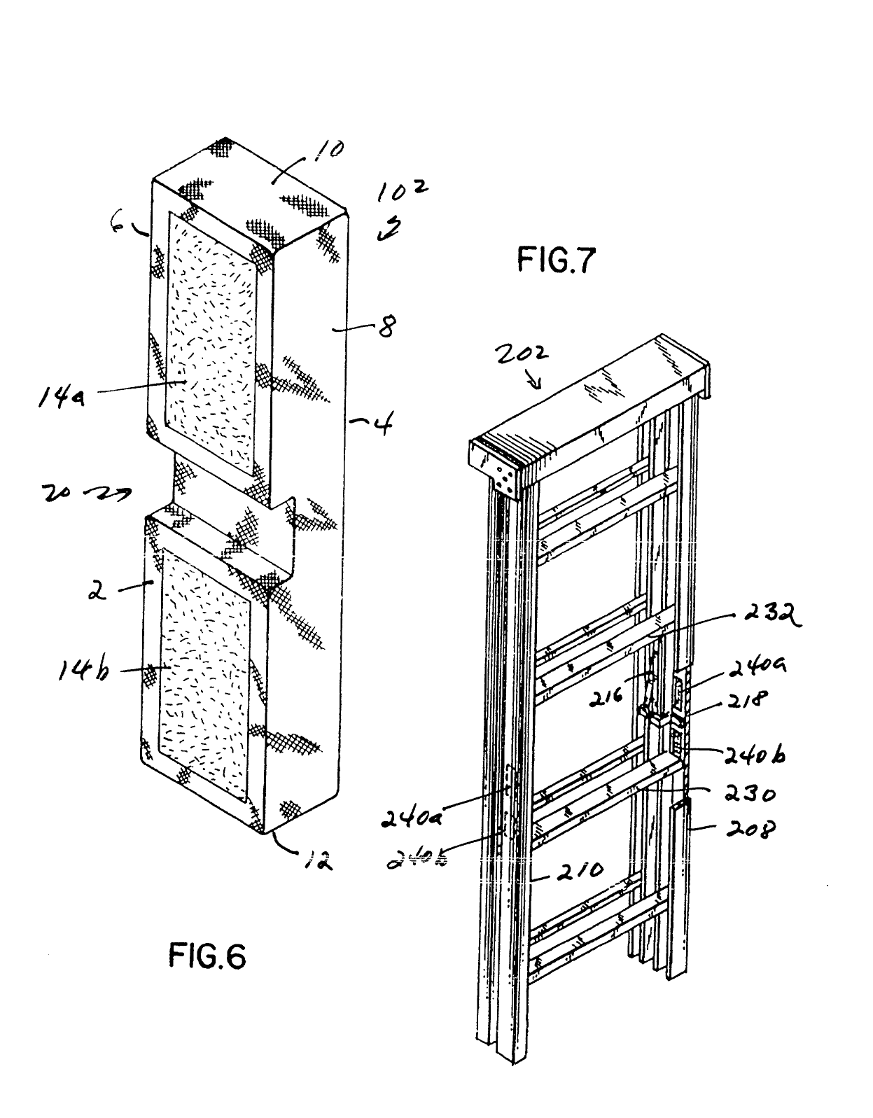

FIG. 6 shows a modified preferred embodiment of the ladder pad device according to the present invention. As may be seen, the ladder pad has been notched at its midpoint. The notch measures about one-half inch deep by one and one-half inch wide by two and five-eighths inches long. The “length” of the notch extends across the width of the ladder pad device.

The notched area 20 allows the ladder pad to fit securely over any inside rail bracing means between balance point rungs 230 and 232 on a standard six-foot fiberglass ladder. Both the size and the location of the notch may vary according to where it is needed on the ladder pad to permit flush engagement between the side face 2 of the ladder pad and the leg of a ladder.

The area of the attachment strip 14 will be slightly reduced due to the notched area.

FIG. 7 shows a fiberglass stepladder 202 having a bracing strap 218 attached to one leg 208. In this case, cooperating fastening means 240a and 240b may be placed on either side of the strap 218 for cooperation with attachment strips 14a and 14b of the ladder pad device.

For example, the attachment means 14 on the ladder pad device and cooperating fastening means 240 on the ladder may be Velcro. Alternatively, the attachment means 14 on the ladder pad device may include an adhesive sheet which attaches to the respective leg of the ladder 202.

From the above, it should be understood that the embodiments described, in regard to the drawings, are merely exemplary and that a person skilled in the art may make variations and modifications to the shown embodiments without departing from the spirit and scope of the invention. All such variations and modifications are intended to be included within the scope of the invention as defined by the appended claims.

What is claimed is:

1. A ladder pad device, adapted to be attached to a ladder having at least two legs and a plurality of rungs therefrom, for relieving stress while carrying the ladder, said device having a padded cushion member having a plurality of side faces; a top face connected to the plurality of side faces; a bottom face connected to a plurality of side faces; and fastening means disposed on one of the side faces to attach the device to one leg of the ladder.

2. A device as in claim 1, wherein said cushion member is a rectangular parallelepiped in shape and has four side faces.

3. A device as in claim 2, wherein the fastening means is longitudinal in shape.

4. A device as in claim 1, wherein the fastening means is an attachment strip.

5. A device as in claim 4, wherein the fastening means is selected from the group consisting of Velcro, rivets, snaps, and sticky back adhesive.

6. A device as in claim 1, wherein the plurality of side faces are fabricated from a flexible material selected from the group consisting of canvas, polypropylene, rubber, nylon, and spandex.

7. A device as in claim 1, wherein the bottom face is fabricated from a flexible material selected from the group consisting of canvas, polypropylene, rubber, nylon, and spandex.

8. A device as in claim 1, wherein the top face is fabricated from a flexible material selected from the group consisting of canvas, polypropylene, rubber, nylon, and spandex.

9. A device as in claim 1, wherein the plurality of side faces, top face, and bottom face are constructed from a durable sewn outside cover over a piece of weather resistant styrofoam fill.

10. A device as in claim 1, wherein at least one side face is fabricated from a material which provides an anti-slip surface.

11. A device as in claim 2, wherein said one side face has a width of approximately two and five-eighths inches to allow the device to have a secure fit to the ladder.

12. A device as in claim 2, wherein the top face has a width of approximately one and three-eighths inches.

13. A device as in claim 2, wherein the bottom face has a width of approximately one and three-eighths inches.

14. A device as in claim 2, wherein each of the plurality of side faces has a length of about eleven inches.

15. A device as in claim 1, wherein said one side face has a recess, permitting flush engagement between said one side face and said leg of a ladder.

16. A device as in claim 11, wherein said one side face has a rectangular notch which is about one-half inch deep, about one and one-half inches wide and about two and five-eighths inches long, permitting flush engagement between said one side face and said leg of a ladder.

17. A ladder pad device adapted to be attached to a ladder for relieving stress while carrying the ladder, said device comprising, in combination:
a padded cushion member having a given shape; and
means affixed to a portion of the shape for attaching the cushion member to the ladder.

18. A ladder pad device as in claim 17, wherein the shape is selected from the group consisting of rhomboid, spherical, rectangular, and square.

19. A ladder pad device as in claim 18, wherein the attaching means is longitudinal in shape.

20. A ladder pad device as in claim 17, wherein the attaching means is selected from the group consisting of Velcro, rivets, snaps, and sticky back adhesive.
